(19) United States
(12) Patent Application Publication
(10) Pub. No.: US 2020/0197980 A1
(43) Pub. Date: Jun. 25, 2020

(54) A SEGREGATION UNIT FOR A SOLID WASTE MANAGEMENT SYSTEM AND A METHOD OF SEGREGATING THEREOF

(71) Applicant: TRASHCON LABS PRIVATE LIMITED, Bangalore, Karnataka (IN)

(72) Inventors: Antony Raj M.A.L, Bengaluru, Karnataka (IN); Anupama V. Joshi, Bengaluru, Karnataka (IN); Aishwarya Pantula, Nagpur, Maharashtra (IN); Manasvi Hemant Paradkar, Bengaluru, Karnataka (IN); Nivedha R.M, Bijapur, Karnataka (IN)

(21) Appl. No.: 16/641,424

(22) PCT Filed: Aug. 23, 2018
(86) PCT No.: PCT/IB2018/056398

§ 371 Date: Feb. 24, 2020

(30) Foreign Application Priority Data
Aug. 24, 2017 (IN) 201741030082

(51) Int. Cl. B07B 4/02; B02C 23/20

(52) U.S. Cl. CPC B07B 4/02; B02C 23/20

(57) ABSTRACT

Present disclosure relates to a segregation unit (100) for a solid waste management system (200). The segregation unit (100) comprises an enclosure (1), defined with at least one inlet portion (2), to receive shredded solid waste (3). The enclosure (1) is adapted to define a compartment (4), to store the shredded solid waste (3). Further, a flow creation device (5) is in fluid communication with the enclosure (1). The flow creation device (5) is configured to create a flow of the shredded solid waste (3) entering the enclosure (1) through the at least one inlet portion (2) such that, the shredded solid waste (3) is segregated, based on volumetric mass, across the compartment (4). This may help in segregating biodegradable waste from non-biodegradable waste, based on volumetric mass.

### TECHNICAL FIELD

Present disclosure relates to the field of material handling and management systems. Particularly, but not exclusively, the present disclosure relates to a solid waste management system. Further, embodiments of the present disclosure relates to a segregation unit for the solid waste management system, and a method of segregation thereof.

### BACKGROUND

In general, commercial, industrial, and residential establishments generate large amounts of throw-away waste and waste products, which comprises majority of solid waste. Such solid waste needs to be handled and disposed-off in a way which does not cause environmental hazards. Further, it may be a tedious task to segregate the solid waste generated from residential and commercial establishments, which in-turn may require abundant infrastructure such as, but not limited to, a number of waste collection bins, a management system to organize collection of solid waste, and the like. These activities may eventually be an expensive and cumbersome process, which in-turn creates havoc within the community for collection and segregation of such solid wastes. In addition, at the households or community level, there may not be adequate awareness in terms of waste management, due to lack of knowledge pertaining to nature of waste, and the manner of categorizing thereto. This may in-turn cause problems associated with valuation of the waste for aftertreatment.

Conventionally, the solid waste may be disposed of by at least one of dumping waste in a land fill or through incineration process. However, these methods of disposal of the solid waste may result in pollution of the environment, such as, but not limited to, contamination of soil, water, and air. In addition, there are certain environmental restrictions as well, for the landfills, in dumping the solid waste.

On the other hand, there are numerous efforts made to segregate the solid waste by manual process, however, this may expose workmen to unhygienic conditions. Also, the manual segregation process may be inaccurate in nature, due to involvement of human errors.

Moreover, manual process may not be feasible for larger amounts of solid waste which may involve huge man-power and labour costs. Additionally, there are conventional machines developed for mechanically recycling and reusing the solid waste. Nonetheless, the conventional mechanical waste segregators have lower efficiency levels, high fuel consumption rate, and increased energy costs thereby leading to inefficient operation. Further, the conventional mechanical waste segregators require larger chambers for accommodating waste. Subsequently, space requirement also is a challenge and may involve difficulty in transporting, assembling and placing the segregator in operation, particularly in remote locations. In addition, the municipal solid waste segregators are generally complex and require much more manpower and are operationally uneconomical.

The present disclosure is directed to overcome one or more limitations stated above or any other limitation associated with the conventional systems.

### SUMMARY OF THE DISCLOSURE

One or more shortcomings of the conventional system are overcome by a system and a method as disclosed and additional advantages are provided through the system and the method as described in the present disclosure.

Additional features and advantages are realized through the techniques of the present disclosure. Other embodiments and aspects of the disclosure are described in detail herein and are considered a part of the claimed disclosure.

In one non-limiting embodiment of the present disclosure, a segregation unit for a solid waste management system is disclosed. The segregation unit comprises an enclosure, which is defined with at least one inlet portion, to receive shredded solid waste. The enclosure is adapted to define a compartment, to store the shredded solid waste. Further, a flow creation device is included in the segregation unit, where the flow creation device is in fluid communication with the enclosure. The flow creation device is configured to create a flow of the shredded solid waste entering the enclosure through the at least one inlet portion such that, the shredded solid waste is segregated, based on volumetric mass, across the compartment.

In an embodiment, the flow creation device is a blower, positioned downstream of the at least one inlet portion. The blower is configured to discharge pressurized air towards the shredded solid waste entering the enclosure through the at least one inlet portion.

In an embodiment, the flow creation device is a suction device, positioned away from the at least one inlet portion. The suction device is configured to create low pressure area at the entry of the shredded solid waste, for segregation.

In an embodiment, the segregation unit comprises a plurality of bins, which is defined in the compartment. Each of the plurality of bins is adapted to collect the segregated shredded solid waste.

In an embodiment, the shredded solid waste is adapted to be collected in each of the plurality of bins based on the volumetric mass.

In an embodiment, the segregation unit comprises a channel extending from at least one wall of the enclosure, wherein the channel conveys the shredded solid waste having lighter volumetric mass. Further, a cyclone generation device is connectable to the channel, where the cyclone generation device receives the shredded solid waste having lighter volumetric mass from the channel, to be disposed-off to the surrounding.

In an embodiment, the segregation unit comprises at least one doorway defined in at least one wall of the enclosure to provide access to the compartment of the enclosure.

In another non-limiting embodiment of the present disclosure, a method of operating a segregation unit for segregating a shredded solid waste in a solid waste management system is disclosed. The method comprises steps of supplying, the shredded solid waste to an enclosure through at least one inlet portion defined in the enclosure. The enclosure is adapted to define a compartment, to store the shredded solid waste. Further, the shredded solid waste is segregated based on volumetric mass of each of the shredded solid waste across the compartment, by creating a flow of the shredded solid waste entering the enclosure, by a flow creation device. In an embodiment, the method comprises collecting the segregated shredded solid waste in a plurality of bins defined in the compartment of the enclosure.

In an embodiment, the method comprises conveying the shredded solid waste having lighter volumetric mass through a channel, extended from at least one wall of the enclosure.

In an embodiment, comprises disposing the shredded solid waste having lighter volumetric mass from the channel to the surrounding, by a cyclone generation device connectable to the channel.

In yet another non-limiting embodiment of the present disclosure, a solid waste management system is disclosed. The system comprises a feeder unit, which is adapted to convey solid waste to a shredding unit. The shredding unit is configured to shred the solid waste. Further, a segregation unit is in communication with the shredding unit. The segregation unit comprises an enclosure, which is defined with at least one inlet portion to receive shredded solid waste. The enclosure is adapted to define a compartment, to store the shredded solid waste. Additionally, a flow creation device is provisioned in the segregation unit, and supported by at least one wall of the enclosure. The flow creation device is configured to create a flow of the shredded solid waste entering the enclosure such that, the shredded solid waste is segregated based on volumetric mass, across the enclosure. Also, a plurality of bins is defined in the compartment of the segregation unit, where each of the plurality of bins is adapted to collect the segregated shredded solid waste.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING FIGURES

The novel features and characteristics of the disclosure are set forth in the appended description. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 is a perspective view of a segregation unit for a solid waste management system, in accordance with an embodiment of the present disclosure.

FIG. 2 is a sectional view of the segregation unit of FIG. 1.

FIG. 3 is a perspective view of a plurality of bins defined in the segregation unit, in accordance with an embodiment of the present disclosure.

FIG. 4 illustrates sectional view of another embodiment of the segregation unit of FIG. 2.

FIG. 5a illustrates a perspective view of a solid waste management system, in accordance with an embodiment of the present disclosure.

FIG. 5b illustrates perspective view of a solid waste management system, in accordance with another embodiment of the present disclosure.

The figures depict embodiments of the disclosure for purposes of illustration only. One skilled in the art will readily recognize from the following description that alternative embodiments of the methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the description of the disclosure. It should also be realized by those skilled in the art that such equivalent systems, mechanisms, and methods which do not depart from the scope of the disclosure. The novel features which are believed to be characteristic of the disclosure, as to system and method of operation, together with further objects and advantages will be better understood from the following description, when considered in connection with the accompanying figures. It is to be expressly understood, however, that each of the figures is provided for the purpose of illustration and description only and is not intended as a definition of the limits of the present disclosure.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a method that comprises a list of acts does not include only those acts but may include other acts not expressly listed or inherent to such system and method thereof. In other words, one or more acts in the system and the method proceeded by “comprises . . . a” does not, without more constraints, preclude the existence of other acts or additional acts in the method.

Embodiments of the present disclosure disclose a segregation unit for a solid waste management system. The segregation unit comprises an enclosure, defined with at least one inlet portion, to receive shredded solid waste. The enclosure is defined with a compartment, to store the shredded solid waste. Further, a flow creation device is in fluid communication with the enclosure. The flow creation device is configured to create a flow within the enclosure such that, the shredded solid waste entering the enclosure through the at least one inlet portion is segregated, based on volumetric mass, across the compartment. This may help in segregating biodegradable waste from non-biodegradable waste, based on volumetric mass. Thus, ensuring proper aftertreatment for the shredded solid waste, for renewing or recycling or disposal.

Henceforth, the present disclosure is explained with the help of figures of a segregation unit and a solid waste management system thereof. However, such exemplary embodiments should not be construed as limitations of the present disclosure, since the system may be used on other types of feeders or conveyers, shredders or crushers, separators, and the like. A person skilled in the art can envisage various such embodiments without deviating from scope of the present disclosure.

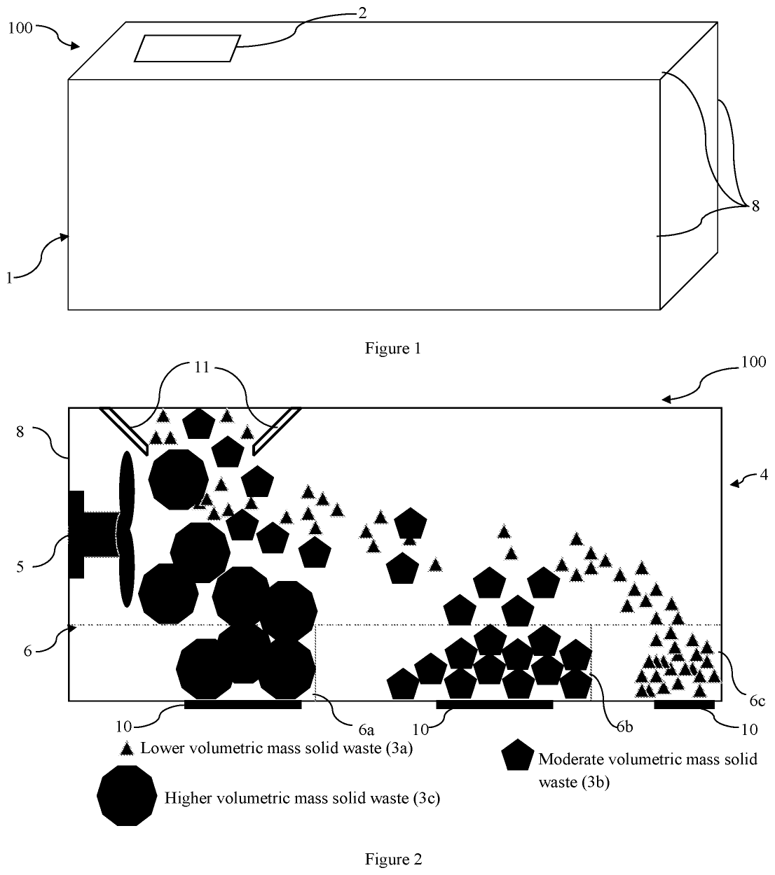

FIG. 1 is an exemplary embodiment of the present disclosure, which illustrates a perspective view of a segregation unit (100) for a solid waste management system (200). The segregation unit (100) is configured to segregate, shredded solid waste (3). In an embodiment, the shredded solid waste (3) may be at least one of residential waste, municipal waste, and any other dry solid waste which is shredded to predetermined finer particles. This shredded solid waste (3) may consist of solid waste of different volumetric masses. The segregation unit (100) would assist in selectively categorizing the shredded solid waste (3) based on volumetric mass, thereby enabling in effortless segregation for aftertreatment and disposal into the surroundings. Further, the segregation unit (100) includes an enclosure (1), where the enclosure (1) is defined by a plurality of walls (8). The plurality of walls (8) may be connectable to one another to define a compartment (4), which may be configured to receive and store the shredded solid waste (3). In an embodiment, the plurality of walls (8) may be at a top surface, a bottom surface, one or more side surfaces, a front surface, and a rear surface, for profiles of the enclosure (1) which may include, but not limited to, triangular, rectangular, pentagonal, and the like. Nonetheless, the plurality of walls (8) may be construed as a single wall for the enclosure (1) having a cylindrical profile.

Additionally, one of the plurality of walls (8) may be defined with at least one inlet portion (2) such that, the shredded solid waste (3) may be introduced into the segregation unit (100). In an exemplary embodiment, the at least one inlet portion (2) is defined on one of the plurality of walls (8) which is preferably a top portion of the enclosure (1) such that, the shredded solid waste (3) may be received by the compartment (4) due to action of gravity. However, the shredded solid waste (3) may also be introduced along a bottom side or any of side portions of the enclosure (1), based on requirement and/or configuration of the enclosure (1). The at least one inlet portion (2) may be defined with a receiving member (11), in order to congregate the shredded solid waste (3) for disposal within the compartment (4).

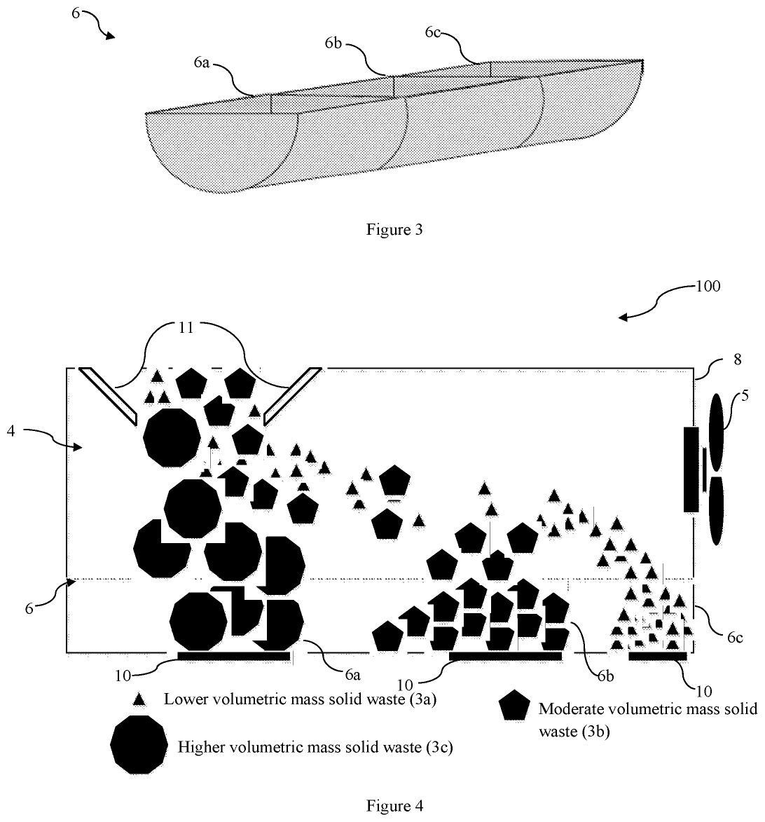

Referring now to FIG. 2, which is a sectional view of the segregation unit (100), in accordance with an embodiment of the present disclosure. The segregation unit (100) may be in fluid communication with a flow creation device (5), where the flow creation device (5) may include, but not limited to, a blower [as shown in FIG. 2], a suction device [as shown in FIG. 3], and the like. The flow creation device (5) may be supported by at least one wall of the plurality of walls (8) of the enclosure (1) such that, the flow creation device (5) fluidly engages with the shredded solid waste (3) introduced therein. The flow creation device (5) may be connected and/or mounted to the at least one of the wall of the plurality of walls (8) such that, the flow creation device (5) is either positioned within the enclosure (1) or may be positioned outside the enclosure (1). In an embodiment, the flow creation device (5) may be connected and/or mounted by means including, but not limited to, fastening, welding, brazing, clamping, and the like. Further, the flow creation device (5) is configured to create a flow of fluid that impacts the shredded solid waste (3), upon entering the enclosure (1) through the at least one inlet portion (2). This flow of fluid through the shredded solid waste (3) disperses the shredded solid waste (3), and in-turn leads to segregation, of the shredded solid waste (3), based on volumetric mass. The segregation of the shredded solid waste (3) is due to application of pressure difference within the enclosure (1) from the fluid such as, but not limited to, air, on the shredded solid waste (3), by the flow creation device (5). The segregated shredded solid waste (3) may then be collected in a plurality of bins (6), defined in the compartment (4), as best seen in FIG. 3. The plurality of bins (6) may collect the segregated shredded sloid waste (3), based on corresponding volumetric mass of the shredded solid waste (3) being dispersed. Due to this dispersion across the compartment (4), the segregated solid waste (3) may be collected in the plurality of bins (6), as a distinct stock, in accordance with corresponding volumetric mass. For example, each of the plurality of bins (6) may be adapted to collect the segregated shredded solid waste (3) having a specific volumetric mass. That is, one of the plurality of bins (6) may be adapted to collect the segregated shredded solid waste (3) having either of lighter volumetric mass (3a) or moderate volumetric mass (3b) or higher volumetric mass (3c), based on position of the bin and nature of the flow creation device (5).

In an embodiment, the blower is employed as the flow creation device (5) [shown in FIG. 2]. The blower may be positioned proximal to the at least one inlet portion (2), in order to impart a positive pressure of the fluid flow on the shredded sloid waste (3) entering the compartment (4). The blower may be positioned downstream to the at least one inlet portion (2). This position of the blower may assist in effective discharging of pressurized fluid [herein referred to as air] towards the shredded solid waste (3) for segregation, as shown in FIG. 2. Due to this pressurized fluid, the shredded solid waste (3) having lighter volumetric mass (3a) may be dispersed farthest away from the at least one inlet portion (2), and in-turn may be collected in one of the plurality of bins (6) positioned farthest away from the flow creation device (5). On the other hand, the shredded solid waste (3) having higher volumetric mass (3c) in comparison with the shredded solid waste (3) having lighter volumetric mass (3a), be negligibly affected by the pressurized air discharged from the flow creation device (5). Due to this, the shredded solid waste (3) having the higher volumetric mass (3c) may be collected in one of the plurality of bins (6) positioned closer to the flow creation device (5). For example, the segregated shredded solid waste (3) having lighter volumetric mass (3a) may be collected in the farthest bin (6c) of the plurality of the bins (6), positioned farthest away from the flow creation device (5). Similarly, the segregated shredded solid waste (3) having moderate volumetric mass (3b), in comparison with the lighter volumetric mass (3a), may be collected in an intermediate bin (6b), positioned in-between the closest and the farthest located plurality of bins (6a and 6c). Meanwhile, the segregated shredded solid waste (3) having higher volumetric mass (3c) may be collected in a plurality of bins (6a) located closest to the flow creation device (5).

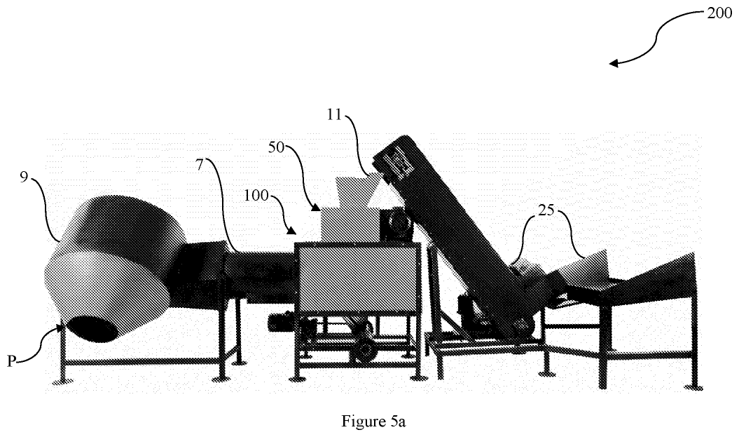

In an embodiment, the flow creation device (5) may also be configured as the suction device [shown in FIG. 4], which generates a negative pressure fluid flow on the segregated solid waste (3). The flow creation device (5) may be positioned away from the at least one inlet portion (2), in order to impart the negative fluid flow pressure on the shredded solid waste (3), for segregation. The flow creation device (5) may be connected to the at least one of the walls of the plurality of walls (8) of the enclosure (1) which may be located away from the at least one inlet portion (2), as shown in FIG. 4. Due to this, the negative fluid flow pressure is exerted on the shredded solid waste (3), and lighter volumetric mass (3a) of each of the shredded solid waste (3) may be drawn away from the at least one inlet portion (2), and in-turn may be collected in one of the plurality of bins (6) positioned proximal to the flow creation device (5). The shredded solid waste (3) having the lighter volumetric mass (3a) being drawn away from the inlet portion (2) travels across the compartment (4), under the influence of the negative pressure exerted by the suction device. On the other hand, the shredded solid waste (3) having higher volumetric mass (3c) may, in comparison with the shredded solid waste (3) having lighter volumetric mass (3a), be negligibly affected due to the negative pressure created by the suction device. Due to this, the shredded solid waste (3) having the higher volumetric mass (3c) may be collected in one of the plurality of bins (6) positioned away from the flow creation device (5), while being proximal to the at least one inlet portion (2). For example, the segregated shredded solid waste (3) having lighter volumetric mass (3a) may be collected in the farthest bin (6c) of the plurality of the bins (6), positioned proximal from the flow creation device (5). Similarly, the segregated shredded solid waste (3) having moderate volumetric mass (3b), in comparison with the lighter volumetric mass (3a), may be collected in an intermediate bin (6b) of the plurality of the bins (6), positioned distal from the flow creation device (5). Meanwhile, the segregated shredded solid waste (3) having higher volumetric mass (3c) may be collected in a closest bin (6a) of the plurality of the bins (6), positioned distal from the flow creation device (5).

In an embodiment, at least one doorway (10) may be defined in the enclosure (1), as best seen in FIGS. 2 and 4. The at least one doorway (10) may provide an access to the compartment (4) of the enclosure (1), for withdrawing the segregated shredded solid waste (3) collected in the plurality of bins (6). Further, the plurality of bins (6) may not be limited to any container and/or a storage unit for collecting the shredded solid waste (3), as the segregated shredded solid waste (3) may also be channelized to a receiving portion of a device for aftertreatment of the segregated shredded solid waste (3).

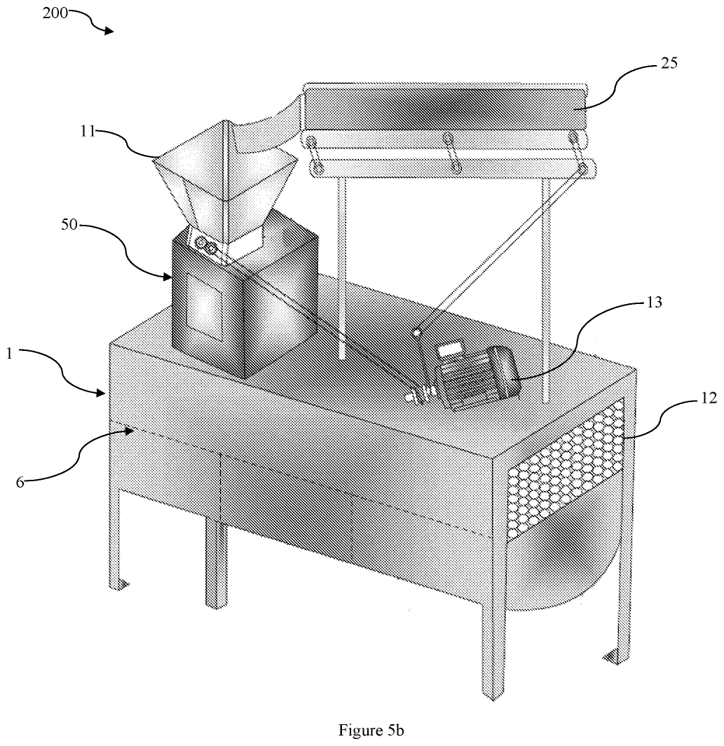

Turning now to FIG. 5, which is an exemplary embodiment of the present disclosure illustrating the solid waste management system (200). The solid waste management system (200) includes a feeder unit (25), which is adapted to convey solid waste to a shredding unit (50). In an embodiment, the feeder unit (25) may be at least one of a belt conveyer, a roller conveyer, a magnetic conveyor, a hopper conveyor, and the like. The solid waste may be either manually or through a device be dumped onto the feeder unit (25), for being conveyed to the shredding unit (50). The shredding unit (50) is configured to shred the solid waste into predefined fine particles. The predefined fine particles of the shredded solid waste (3) may be in the range of about 1 mm to about 500 mm, based on requirement and nature of the solid waste being shredded. The shredding unit (50) may consist at least one of a series of rotating blades, a series of reciprocating blades, a spiked roller, a toothed roller, and the like. The solid waste management system (200) further includes the segregation unit (100), where the segregation unit (100) is in communication with the shredding unit (50). The segregation unit (100) includes the enclosure (1), having at least one inlet portion (2) which is configured to receive shredded solid waste (3) from the shredding unit (50). The enclosure (1) is adapted to define to store the shredded solid waste (3) received from the shredding unit (50). Further, the segregation unit (100) is provisioned with the flow creation device (5), where the flow creation device (5) is supported by at least one wall of the plurality of walls (8) of the enclosure (1). The flow creation device (5) is configured to create the flow of the shredded solid waste (3) entering the enclosure (1) such that, the shredded solid waste (3) is segregated based on volumetric mass, across the enclosure (1). Additionally, the segregation unit (100) consists of the plurality of bins (6), which are defined in the compartment (4), to collect the segregated shredded solid waste (3), based on corresponding volumetric mass.

Continuing the reference to FIG. 5, the at least one wall of the plurality of walls (8) of the enclosure (1) may be either extended to define a channel (7), or may be configured to be connected by the channel (7) to form an extended portion from the enclosure (1). The channel (7) may be configured to covey the shredded solid waste (3) having lighter volumetric mass (3a) away from the enclosure (1), where the shredded solid waste (3) having lighter volumetric mass (3a) may be conveyed to a cyclone generation device (9). The cyclone generation device (9) may be configured to generate a swirl of the shredded solid waste (3) having lighter volumetric mass (3a), by a pneumatic fluid. Due to this swirl generated by the pneumatic fluid, the shredded solid waste (3) having lighter volumetric mass (3a) tends to collide with refractory of the cyclone generation device (9), under the action of centripetal force. The collision of the shredded solid waste (3) having lighter volumetric mass (3a) may then gradually decrease its momentum, and in-turn dispose-off the shredded solid waste (3) having lighter volumetric mass (3a) through an exit portion (P) defined therein. The shredded solid waste (3) having lighter volumetric mass (3a) is then discharged from the surroundings for aftertreatment. At this juncture, the pneumatic fluid may be channelized to the surroundings, through one or more vents [not shown in Figures] defined opposite to the exit portion (P). Additionally, it may be noted that, due to provision of the cyclone generation device (9), the pressure developed within the enclosure (1) may be streamlined, thereby inhibiting development of excess pressure within the enclosure (1).

FIG. 6 is another embodiment of the solid waste management system (200). The operation of the solid waste management system (200) of FIG. 6 is similar to the operation of the solid waste management system (200) of FIG. 5. However, instead of the cyclone generation unit, a perforated opening (12) may be defined on the at least one wall (8) of the enclosure (1), which may intersect the flow of the shredded solid waste (3). Due to provision of the perforated opening (12), the shredded solid waste (3) having lighter volumetric mass (3a) may be directly discharged off to the surroundings through this perforated opening (12).

In an embodiment, the segregated shredded solid waste (3) having lighter volumetric mass (3a) may be including, but may not be limited to, non-biodegradable materials. The non-biodegradable materials may be such as, but not limited to, polymers, and the like.

In an embodiment, the segregated shredded solid waste (3) having heavier volumetric mass may be including, but may not be limited to, biodegradable materials. The biodegradable materials may be such as, but not limited to, vegetable waste, and the like.

In an embodiment, the flow creation device (5), the feeder unit (25), the shredding unit (50), and the cyclone generator device (9) may be driven by a motor (13). The motor (13) may be operated AC or DC means, in accordance with requirement of mode of operations.

In an embodiment of the present disclosure, the solid waste is segregated with either minimal or no human intervention.

In an embodiment of the present disclosure, the segregation unit is compact in size, thereby avoiding problems associated with space constrains.

### EQUIVAENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system (100) having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system (100) having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Particulars | Numeral |
|---|---|
| Enclosure | 1 |
| Inlet portion | 2 |
| Shredded solid waste | 3 |
| Shredded solid waste having lighter volumetric mass | 3a |
| Shredded solid waste having moderate volumetric mass | 3b |
| Shredded solid waste having higher volumetric mass | 3c |
| Compartment | 4 |
| Flow control device | 5 |
| Blower | 5a |
| Suction device | 5b |
| Bins | 6 |
| Channel | 7 |
| Wall | 8 |
| Cyclone generation device | 9 |
| Doorway | 10 |
| Receiving member | 11 |
| Perforated portion | 12 |
| Motor | 13 |
| Exit portion | P |
| Feeder unit | 25 |
| Shredding unit | 50 |
| Segregation unit | 100 |
| Solid waste management | 200 |

1. A segregation unit (100) for a solid waste management system (200), the segregation unit (100) comprising:
an enclosure (1) defined with at least one inlet portion (2), to receive shredded solid waste (3), wherein the enclosure (1) is adapted to define a compartment (4), to store the shredded solid waste (3); and
a flow creation device (5) in fluid communication with the enclosure (1), the flow creation device (5) is configured to create a fluid pressure, to facilitate flow of the shredded solid waste (3) entering the enclosure (1) through the at least one inlet portion (2) such that, the shredded solid waste (3) is segregated, based on volumetric mass, across the compartment (4).

2. The segregation unit (100) as claimed in claim 1, wherein the flow creation device (5) is a blower (5a), positioned downstream of the at least one inlet portion (2).

3. The segregation unit (100) as claimed in claim 2, wherein the blower (5a) is configured to discharge pressurized air towards the shredded solid waste (3) entering the enclosure (1) through the at least one inlet portion (2).

4. The segregation unit (100) as claimed in claim 1, wherein the flow creation device (5) is a suction device (5b), positioned away from the at least one inlet portion (2).

5. The segregation unit (100) as claimed in claim 4, wherein the suction device (5b) is configured to create low pressure area at the entry of the shredded solid waste (3), for segregation.

6. The segregation unit (100) as claimed in claim 1, comprises a plurality of bins (6) defined in the compartment (4), wherein each of the plurality of bins (6) is adapted to collect the segregated shredded solid waste (3).

7. The segregation unit (100) as claimed in claim 6, wherein the shredded solid waste (3) is adapted to be collected in each of the plurality of bins (6) based on the volumetric mass.

8. The segregation unit (100) as claimed in claim 1, comprises a channel (7) extending from at least one wall (8) of the enclosure (1), wherein the channel (7) conveys the shredded solid waste (3) having lighter volumetric mass.

9. The segregation unit (100) as claimed in claim 8, comprises a cyclone generation device (9) connectable to the channel (7), wherein the cyclone generation device (9) receives the shredded solid waste (3) having lighter volumetric mass from the channel (7), to be disposed-off to the surrounding.

10. The segregation unit (100) as claimed in claim 1, comprises at least one doorway (10) defined in at least one wall (8) of the enclosure (1) to provide access to the compartment (4) of the enclosure (1).

11. A method of operating a segregation unit (100) for segregating a shredded solid waste (3) in a solid waste management system (200), the method comprising:
supplying, the shredded solid waste (3) to an enclosure (1) through at least one inlet portion (2) defined in the enclosure (1), wherein the enclosure (1) is adapted to define a compartment (4), to store the shredded solid waste (3); and
segregating, the shredded solid waste (3) based on volumetric mass of each of the shredded solid waste (3) across the compartment (4), by creating a fluid pressure, to facilitate flow of the shredded solid waste (3) entering the enclosure (1), by a flow creation device (5).

12. The method as claimed in claim 11, comprises collecting the segregated shredded solid waste (3) in a plurality of bins (6) defined in the compartment (4) of the enclosure (1).

13. The method as claimed in claim 11, comprises conveying the shredded solid waste (3) having lighter volumetric mass through a channel (7), extended from at least one wall (8) of the enclosure (1).

14. The method as claimed in claim 13, comprises disposing the shredded solid waste (3) having lighter volumetric mass from the channel (7) to the surrounding, by a cyclone generation device (9) connectable to the channel (7).

15. A solid waste management system (200), comprising:
a feeder unit (25) adapted to convey solid waste to a shredding unit (50), wherein the shredding unit (50) is configured to shred the solid waste; and
a segregation unit (100) in communication with the shredding unit (50), the segregation unit (100) comprising:
an enclosure (1) defined with at least one inlet portion (2) to receive shredded solid waste (3), wherein the enclosure (1) is adapted to define a compartment (4), to store the shredded solid waste (3);
a flow creation device (5) supported by at least one wall (8) of the enclosure (1), the flow creation device (5) is configured to create a fluid pressure, to facilitate flow of the shredded solid waste (3) entering the enclosure (1) such that, the shredded solid waste (3) is segregated based on volumetric mass, across the enclosure (1); and
a plurality of bins (6) defined in the compartment (4), wherein each of the plurality of bins (6) is adapted to collect the segregated shredded solid waste (3).
